(19) United States
(12) Patent Application Publication
(10) Pub. No.: US 2016/0240086 A1
(43) Pub. Date: Aug. 18, 2016

(54) METHOD AND DEVICE FOR OPERATING A WATERCRAFT AND FOR OPERATING A HARBOR

(71) Applicant: Robert Bosch GmbH, Stuttgart (DE)

(72) Inventors: Rolf Nicodemus, Bietigheim-Bissingen (DE); Stefan Nordbruch, Kornwestheim (DE)

(21) Appl. No.: 15/019,746

(22) Filed: Feb. 9, 2016

(30) Foreign Application Priority Data
Feb. 12, 2015 (DE) 102015202496.2

(51) Int. Cl. G08G 3/00

(52) U.S. Cl. CPC G08G 3/00

(57) ABSTRACT

A method for operating a watercraft, including transmitting a request for a berth for the watercraft to a harbor management server of a harbor via a communication network, receiving berth-relevant data from the harbor management server via the communication network, moving the watercraft to a berth of the harbor based on the berth-relevant data. A further method for operating a watercraft and methods for operating a harbor, corresponding devices, a watercraft, a harbor management server, and a computer program are also described.

### CROSS REFERENCE

The present application claims the benefit under 35 U.S.C. §119 of German Patent Application No. 102015202496.2 filed on Feb. 12, 2015, which is expressly incorporated herein by reference in its entirety.

### FIELD

The present invention relates to a method for operating a watercraft and a method for operating a harbor. The present invention furthermore relates to a device for operating a watercraft and a harbor management server. The present invention furthermore relates to a watercraft, a harbor, and a computer program.

### BACKGROUND INFORMATION

German Patent Application No. DE 10 2012 222 562 A1 describes a system for managed parking areas for transferring a vehicle from a starting position into a target position.

In the case of fully automated (autonomous) so-called valet parking, a vehicle is parked by its driver at a drop-off point, for example, in front of a parking garage, and from there the vehicle drives itself into a parking position/parking space and back to the drop-off point.

There is a demand for expanding the concept of valet parking.

### SUMMARY

An object on which the present invention is to provide an efficient way to operate a watercraft in an efficient and improved way.

An object on which the present invention is to provide an efficient way to operate a harbor in an improved and efficient way.

An object on which the present invention is to provide a corresponding harbor management server, a watercraft, and a harbor.

According to one aspect, a method for operating a watercraft is provided, including:
transmitting a request for a berth for the watercraft to a harbor management server of a harbor via a communication network,
receiving berth-relevant data from the harbor management server via the communication network,
moving the watercraft to a berth of the harbor based on the berth-relevant data.

According to another aspect, a method is provided for operating a watercraft located at a berth of a harbor, including:
transmitting a request for clearance of the watercraft for a departure from the berth to a harbor management server of the harbor via a communication network,
receiving departure-relevant data from the harbor management server via the communication network,
moving the watercraft away from the berth based on the departure-relevant data.

According to another aspect, a method is provided for operating a harbor, including:
receiving a request for a berth of a harbor for a watercraft via a communication network,
ascertaining berth-relevant data for the watercraft in response to the reception,
transmitting the berth-relevant data via the communication network, so that the watercraft may be moved to a berth of the harbor based on the berth-relevant data.

According to still another aspect, a method is provided for operating a harbor, including:
receiving a request for clearance of a watercraft for a departure, which is located at a berth of the harbor, from the berth via a communication network,
ascertaining berth-relevant data for the watercraft in response to the reception,
transmitting the berth-relevant data via the communication network, so that the watercraft may be moved away from the berth based on the berth-relevant data.

According to still another aspect, a device is provided for operating a watercraft, which is configured to carry out the method according to the present invention for operating a watercraft and/or for operating a watercraft located at a berth of a harbor.

According to another aspect, a harbor management server is provided, which is configured to carry out the method according to the present invention for operating a harbor.

According to another aspect, a watercraft is provided, which includes the device for operating a watercraft.

According to another aspect, a harbor is provided, which includes the harbor management server according to the present invention.

According to still another aspect, a computer program is provided, which includes program code for carrying out the method for operating a watercraft and/or for operating a watercraft located at a berth of a harbor and/or for operating a harbor when the computer program is executed on a computer.

The present invention thus includes in particular assisting a watercraft during its travel to a berth or during a departure from the berth, respectively, and coordinating the corresponding movement. This takes place in particular in that berth-relevant data are ascertained for the movement of the watercraft to the berth of the harbor and are provided via the communication network. This also takes place in particular in that departure-relevant data for the watercraft are ascertained and transmitted via the communication network, so that the movement, i.e., the departure of the watercraft away from the berth may be carried out based on these data. Improved operation of the watercraft and therefore also improved operation of the harbor are therefore advantageously enabled, insofar as a movement of the watercraft may advantageously be influenced with the aid of the berth-relevant data and/or the departure-relevant data.

According to one specific embodiment, a method is provided, which includes both the steps of the method according to the present invention for operating a watercraft and the steps according to the present invention of the method for operating a watercraft located at a berth of a harbor.

According to one specific embodiment, it is provided that the steps of receiving a request for a berth, ascertaining berth-relevant data, and also transmitting the berth-relevant data, and also the steps of receiving a request for clearance and also ascertaining departure-relevant data and also transmitting the departure-relevant data are all provided. According to this specific embodiment, a method for operating a harbor is therefore provided, in which both the request for the berth is received and a request for clearance is received.

A watercraft within the meaning of the present invention refers in particular to a vehicle which is intended or configured or designed for movement on or in the water. The watercraft may be a muscle-powered vehicle, for example. For example, the watercraft may be a wind-powered watercraft. In particular, the watercraft may be a machine-powered watercraft. A watercraft includes in particular an underwater vehicle, for example, a submarine, i.e., a U-boat, or a vessel.

According to one specific embodiment, it is provided that moving the watercraft includes manual piloting of the watercraft and/or autonomous travel of the watercraft and/or remote-controlled piloting of the watercraft.

This means in particular that the watercraft may be manually piloted. In particular, the watercraft may travel autonomously. In particular, the watercraft may be piloted via remote control. In particular, combinations of the above-mentioned types of movement are provided. The advantage of manual piloting may be considered in particular in that complex sensor systems or processors are not necessary to pilot the watercraft. This is because a human assumes the piloting of the watercraft.

Autonomous travel has the advantage in particular that a human is no longer required for this purpose. Therefore, efficient and effective movement of the watercraft may be enabled. In particular, for example, a human on the watercraft may thus attend to other activities or is relieved by the autonomous driving of the watercraft from the manual piloting tasks and may, for example, turn his attention to other things.

In particular, the remote-controlled piloting of the watercraft has the advantage that the infrastructure required for this purpose does not have to be present in the watercraft itself, which may reduce a technical complexity for the watercraft itself. A multitude of watercraft may thus be piloted remotely controlled, without having to be designed themselves for autonomous driving.

Autonomous within the meaning of the present invention means in particular that the watercraft navigates or drives independently, i.e., without an intervention of a vehicle pilot. The watercraft thus drives or moves independently to the berth. In particular, the watercraft departs independently from the berth.

According to one specific embodiment, it is provided that the watercraft moves to the berth from a position outside or inside the harbor.

According to one specific embodiment, the movement includes parking of the watercraft at the berth, i.e., mooring at the berth.

According to one specific embodiment, the movement includes exiting from the berth, i.e., departure from the berth.

According to one specific embodiment, the movement includes moving the watercraft from a berth to a position outside or inside the harbor.

According to one specific embodiment, a setpoint trajectory is ascertained in each case for the above-mentioned movements, which the watercraft is to travel to reach the appropriate position. The setpoint trajectory is ascertained by the harbor management server and transmitted to the watercraft, for example.

For example, the harbor management server transmits a digital map of the harbor, based on which the watercraft may be moved to the berth or away from the berth, respectively.

According to one specific embodiment, it is provided that corresponding data are transmitted from the harbor management server to a user of the communication network. The user is a terminal, for example, in particular a mobile terminal.

According to one specific embodiment, the device for operating a watercraft, in particular the watercraft, includes such a terminal, for example, a mobile terminal. The watercraft may therefore be referred to as a user of the communication network.

This means in particular that the user, for example, the terminal, for example, the watercraft, thus transmits the request for a berth or for clearance for a departure, respectively, via the communication network to the harbor management server.

It is accordingly provided according to one specific embodiment that the data transmitted from the harbor management server, i.e., in particular the departure-relevant or berth-relevant data, respectively, are received by the user, i.e., in particular by the mobile terminal, in particular the terminal, in particular the watercraft.

It is thus also provided according to one specific embodiment that the harbor management server transmits its ascertained data to the user of the communication network, i.e., in particular to the terminal, in particular to the mobile terminal, in particular to the watercraft.

According to one specific embodiment, the communication network includes a mobile wireless network and/or a WLAN network. In particular, the communication is carried out via the communication network with the aid of radio waves, i.e., in particular in the radio frequency range.

A berth within the meaning of the present invention refers in particular to a location or a position in the harbor, at which the watercraft may be moored or stored. A berth includes in particular a water berth, for example, a jetty, a floating dock, a mole, a pier, a quay, or a pontoon bridge. A berth includes in particular an onshore berth. A berth includes in particular a beach berth. A berth includes in particular a boathouse.

Parking into the berth may be referred to as mooring. Carrying out the mooring includes in particular carrying out one or more mooring maneuvers. In particular, the mooring includes anchoring.

The departure includes in particular departure maneuvers, in particular weighing of an anchor.

The departure and/or the mooring are carried out autonomously according to one specific embodiment. In particular, the mooring and/or departure are carried out remotely controlled according to one specific embodiment. In particular, the mooring and/or departure are carried out manually according to one specific embodiment.

According to one specific embodiment, it is provided that the transmission of the request includes a transmission of watercraft-specific data to the harbor management server via the communication network, so that the harbor management server may ascertain the data to be transmitted to the watercraft based on the watercraft-specific data.

This yields the technical advantage in particular that an optimum berth for the watercraft may be ascertained.

Watercraft-specific data include, for example, a width, a height, and/or a length of the watercraft. Watercraft-specific data include, for example, contact data and/or payment data of a vehicle pilot.

According to one specific embodiment, it is provided that the received data of the harbor management server include surroundings data, in particular current data and/or wind data of the harbor, so that the movement is carried out based on the surroundings data.

This causes the technical advantage in particular that a movement of the watercraft may be carried out in an efficient and improved way. In particular, the movement may take into consideration a current and/or a wind. In particular, a setpoint trajectory may be ascertained based on the surroundings data, which is provided anyway according to one specific embodiment.

According to another specific embodiment, it is provided that correction data are received from the harbor management server during the movement, so that the movement of the watercraft is corrected based on the correction data. This means that the harbor management server transmits these correction data via the communication network.

This yields the technical advantage in particular that the movement may be corrected, so that possible errors or deviations from a setpoint trajectory may be corrected. An improved movement of the vehicle to the corresponding position is thus effectuated. In particular, the watercraft may thus be prevented from colliding with other objects on the water. According to one specific embodiment, it is provided that a setpoint trajectory for the watercraft is corrected or adapted based on the correction data. This means that the correction data are thus used to correct or recalculate a setpoint trajectory.

In another specific embodiment, it is provided that the watercraft is monitored for the ascertainment of the correction data. This takes place in particular with the aid of a monitoring system.

According to one specific embodiment, a monitoring system is provided for monitoring a watercraft. This means that the watercraft is monitored during its movement with the aid of the monitoring system.

According to one specific embodiment, the monitoring system includes one or multiple surroundings sensors. A surroundings sensor is, for example, a video sensor, a radar sensor, a Lidar sensor, a laser sensor, or an ultrasonic sensor.

In particular, the monitoring system includes one or more light barriers. The monitoring system may be referred to as a harbor monitoring system. The monitoring system is preferably configured to receive position data of a position sensor of the watercraft. A position sensor is, for example, a GPS sensor (GPS stands for “global positioning system”). Position data are then GPS data. This means that the position sensor of the watercraft determines an instantaneous position of the watercraft. The position data corresponding to the instantaneous position are transmitted in particular with the aid of a communication interface via a communication network to the monitoring system. This means that the monitoring system thus monitors position data.

According to one specific embodiment, it is provided that, during the movement, watercraft-internal data are monitored and transmitted to the harbor management server via the communication network. This yields the technical advantage in particular that the harbor management server may obtain knowledge about operating states of the watercraft.

Watercraft-internal data include the following data, for example:

Position data of a position sensor of the watercraft and/or travel data from watercraft-intrinsic, i.e., from watercraft-internal systems and/or drive data of a drive of the watercraft and/or rudder data of a rudder of the watercraft and/or damage data relating to damage to the watercraft.

In another specific embodiment it is provided that the watercraft is piloted remotely controlled for moving the watercraft.

In another specific embodiment, it is provided that a movement of the watercraft is monitored and, based on the monitoring, correction data are ascertained and transmitted via the communication network, so that the movement of the watercraft may be corrected.

According to one specific embodiment, it is provided that the reception of the request includes a reception of watercraft-specific data via the communication network, so that the data to be transmitted to the watercraft are ascertained based on the watercraft-specific data.

In another specific embodiment, it is provided that surroundings data, in particular current data and/or wind data, of the harbor are ascertained and transmitted via the communication network, so that the movement may be carried out based on the surroundings data.

According to one specific embodiment, it is provided that the device for operating a watercraft includes a communication interface for transmitting and/or receiving the corresponding data via a communication network.

According to one specific embodiment, it is provided that the harbor management server includes a communication interface for transmitting and receiving corresponding data via a communication network.

According to one specific embodiment, the harbor management server includes a processor, which is designed to ascertain corresponding data.

According to one specific embodiment, the device for operating a watercraft includes a processor, which is configured or designed to ascertain corresponding data.

According to one specific embodiment, the harbor management server includes a remote control unit for the remotely controlled piloting of the watercraft. The remote control unit transmits, for example, remote control data to the watercraft, which are implemented accordingly, for example, by a watercraft-internal controller.

According to one specific embodiment, the device for operating a watercraft includes a control unit for controlling the watercraft. The control unit is designed in particular for piloting or controlling the watercraft autonomously.

The present invention is explained in greater detail hereafter on the basis of preferred exemplary embodiments.

### BRIEF DESCRIPTION OF THE DRAWINGS

FIG. 1 shows a flow chart of an example method for operating a watercraft.

FIG. 2 shows a flow chart of an example method for operating a watercraft located at a berth of a harbor.

FIG. 3 shows a flow chart of an example method for operating a harbor.

FIG. 4 shows a flow chart of a further example method for operating a harbor.

FIG. 5 shows an example device for operating a watercraft.

FIG. 6 shows an example harbor management server.

FIG. 7 shows an example watercraft.

FIG. 8 shows an example harbor.

### DETAILED DESCRIPTION OF EXAMPLE EMBODIMENTS

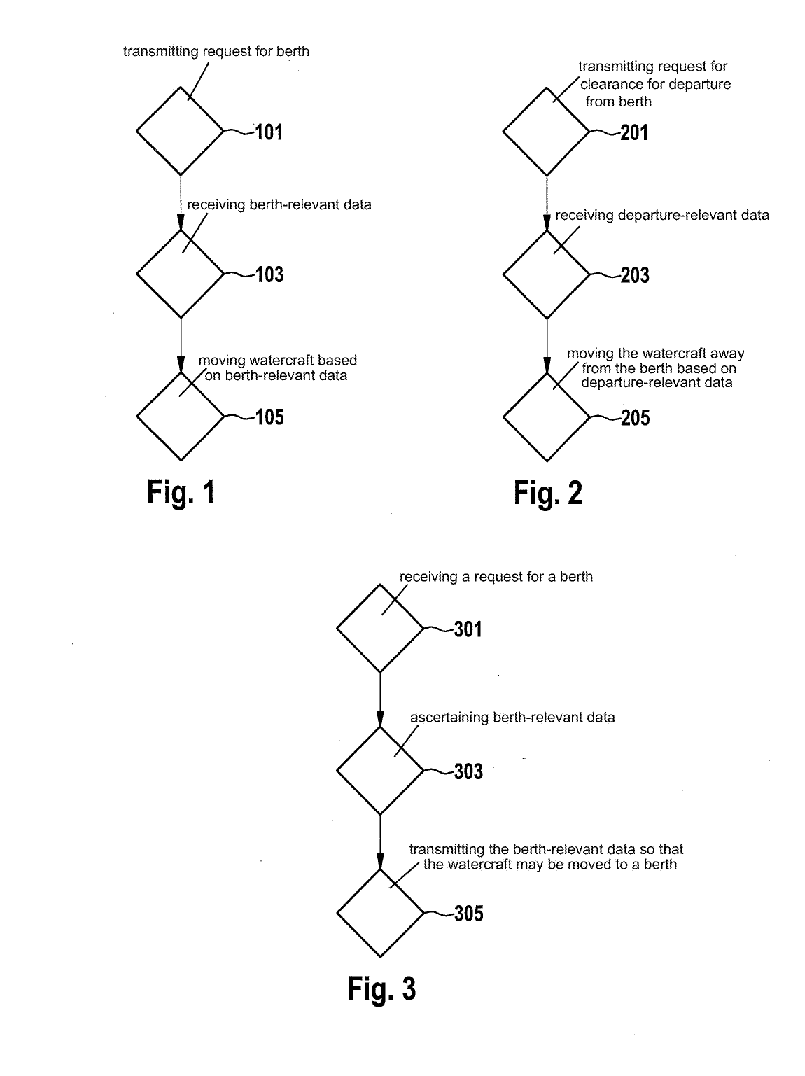

FIG. 1 shows a flow chart of a method for operating a watercraft, including:
transmitting 101 a request for a berth for the watercraft to a harbor management server of a harbor via a communication network,
receiving 103 berth-relevant data from the harbor management server via the communication network,
moving 105 the watercraft to a berth of the harbor based on the berth-relevant data.

FIG. 2 shows a flow chart of a method for operating a watercraft, the watercraft being located at a berth of a harbor, including:
transmitting 201 a request for clearance of the watercraft for a departure from the berth to a harbor management server of the harbor via a communication network,
receiving 203 departure-relevant data from the harbor management server via the communication network,
moving 205 the watercraft away from the berth based on the departure-relevant data.

FIG. 3 shows a method for operating a harbor, including:
receiving 301 a request for a berth of a harbor for a watercraft via a communication network,
ascertaining 303 berth-relevant data for the watercraft in response to the reception,
transmitting 305 the berth-relevant data via the communication network, so that the watercraft may be moved to a berth of the harbor based on the berth-relevant data.

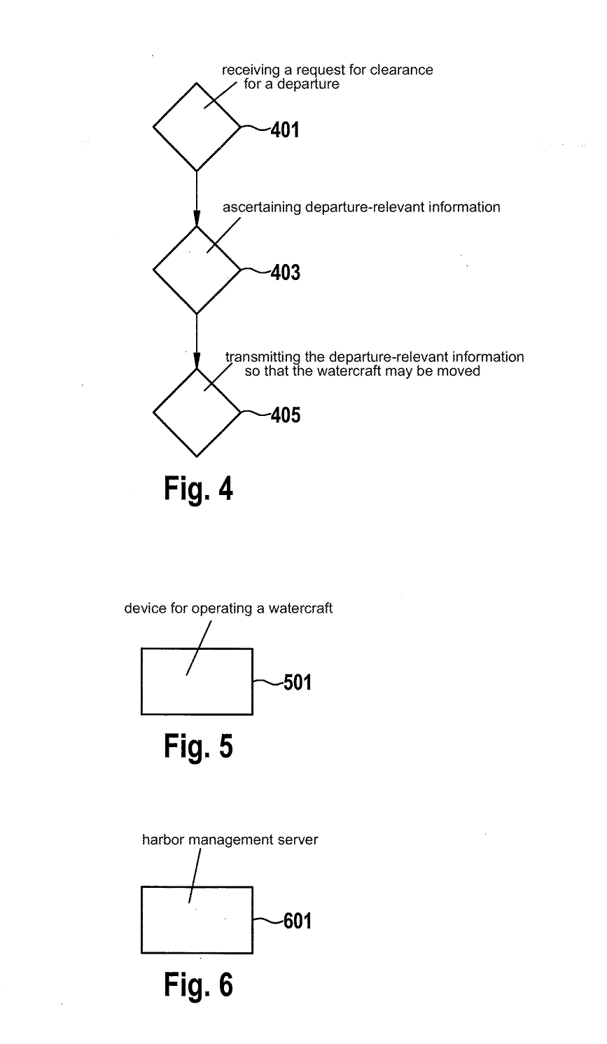

FIG. 4 shows a flow chart of a method for operating a harbor, including:
receiving 401 a request for clearance for a departure of a watercraft located at a berth of the harbor from the berth via a communication network,
ascertaining 403 departure-relevant data for the watercraft in response to the reception,
transmitting 405 the departure-relevant data via the communication network, so that the watercraft may be moved away from the berth based on the departure-relevant data.

In one specific embodiment (not shown), a method for operating a watercraft is provided, which includes steps 101, 103, 105, 201, 203, 205 according to FIGS. 1 and 2, as described above.

According to one specific embodiment, it is provided that a method for operating a harbor is provided, including steps 301, 303, 305, 401, 403, 405, as described above in conjunction with FIGS. 3 and 4.

FIG. 5 shows a device 501 for operating a watercraft, which is configured or designed to carry out or execute the method for operating a watercraft according to FIG. 1 and/or FIG. 2. Device 501 includes, for example, a communication interface and/or a processor.

Device 501 includes, for example, a control unit for autonomous control or piloting of the watercraft.

FIG. 6 shows a harbor management server 601, which is configured or designed to carry out or execute the method for operating a harbor according to FIG. 3 and/or FIG. 4. Harbor management server 601 includes, for example, a communication interface and/or a processor.

In one specific embodiment (not shown), a monitoring system is provided, which monitors a movement of the watercraft and transmits corresponding monitoring data to harbor management server 601.

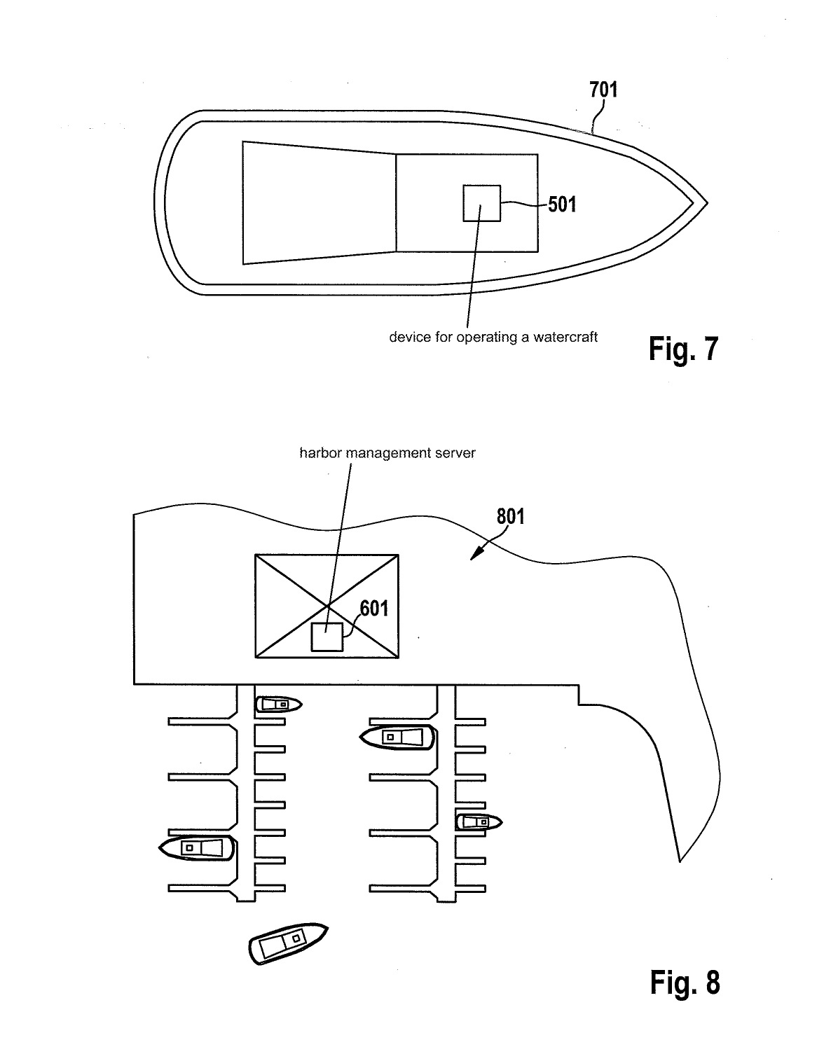

FIG. 7 shows a watercraft 701 including device 501 of FIG. 5.

In one specific embodiment (not shown), device 501 and/or watercraft 701 includes a surroundings sensor system for detecting surroundings of the watercraft. The surroundings sensor system includes, for example, one or multiple surroundings sensors. A surroundings sensor is, for example, an ultrasonic sensor, a radar sensor, a video sensor, a laser sensor, or a Lidar sensor.

FIG. 8 shows a harbor 801, including harbor management server 601 of FIG. 6.

In one specific embodiment (not shown), harbor 801 includes a monitoring system for monitoring a movement of the watercraft.

The present invention thus includes in particular and inter alia the concept of providing an efficient and technical concept, with the aid of which adaptation and/or expansion of the principle of valet parking in conjunction with land vehicles, in particular automobiles, is enabled for the marine sector/harbor sector.

According to the present invention, a watercraft requests a parking space, i.e., a berth. Furthermore, according to the present invention, a harbor management server, which may also be referred to as a management system of the harbor, ascertains a parking space, i.e., a berth, and assigns it to the watercraft. According to the present invention, the watercraft travels or is piloted manually or remotely controlled or autonomously/independently to the berth. A combination of manual movement, remotely controlled movement or piloting, and autonomous piloting or moving may also be provided. Thus, for example, a part of the movement may be carried out manually. A further part of the movement may be carried out remotely controlled, for example. A further part of the movement may be carried out autonomously, for example.

The movement is carried out in particular based on transmitted data. These data are thus transmitted from the harbor management server to the watercraft, for example. Such data include, for example, a target position, i.e., for example, the berth or a position outside or inside the harbor. Such data include, for example, a digital map of the harbor. Data include, for example, one or multiple setpoint trajectories for the watercraft. In particular, data include remote control data.

The watercraft travels or moves to the parking space, i.e., to the berth, based on these data and parks therein. This means that the watercraft moors there.

According to one specific embodiment, the watercraft departs again, i.e., moves away from the berth, and travels back out of the harbor, similarly to the mooring, i.e., to the travel or movement of the vehicle to the berth. This means in particular that the watercraft thus moves away from the berth, i.e., in particular departs therefrom. The watercraft then travels, for example, out of the harbor. This may also be carried out manually or remotely controlled or autonomously. In particular, a combination of these types of movement may be provided.

Within the query or request for a berth, according to one specific embodiment, parking-relevant data of the watercraft (for example, width, height, length) and also contact data, payment data, etc. are also transmitted, so that the management system, i.e., the harbor management server, may reserve an optimum parking space, i.e., berth, for the watercraft and also for the harbor.

In another specific embodiment, surroundings data of the harbor (wind data and/or current data), which are necessary for the travel or the movement, are also transmitted to the watercraft and/or are included in one or multiple setpoint trajectories.

In another specific embodiment, the watercraft is monitored during the travel or movement in the harbor and/or during a parking/exiting procedure in the parking space/berth by a harbor monitoring system based on surroundings sensors (video, radar, Lidar, ultrasonic, light barriers) for documentation purposes. In particular, the position data of the watercraft are obtained. For example, position data of a position sensor, for example, a GPS sensor, of the watercraft are monitored with the aid of the harbor monitoring system.

In another specific embodiment, it is monitored, using the monitoring data (for example, position data) of the monitoring system, whether the watercraft has deviations from the setpoint trajectory (for example, because of currents and/or wind). If this is to be the case, according to one specific embodiment, this is communicated to the watercraft, so that it adapts, i.e., corrects, the travel (manually or autonomously).

If this is to be the case, so that a deviation has occurred, according to one specific embodiment, the trajectory, i.e., the actual trajectory of the watercraft is adapted in the case of remotely controlled travel.

According to one specific embodiment, vessel-internal data are preferably also monitored and/or documented. These vessel-internal or watercraft-internal data are preferably transmitted to the harbor management server, i.e., in particular to a harbor system.

A watercraft includes in particular a vessel.

The wording “respectively” includes in particular the wording “and/or.”

What is claimed is:

1. A method for operating a watercraft, comprising:
transmitting a request for a berth for the watercraft to a harbor management server of a harbor via a communication network;
receiving berth-relevant data from the harbor management server via the communication network; and
moving the watercraft to a berth of the harbor based on the berth-relevant data.

2. A method for operating a watercraft located on a berth of a harbor, comprising:
transmitting a request for clearance of the watercraft for a departure from the berth to a harbor management server of the harbor via a communication network;
receiving departure-relevant data from the harbor management server via the communication network; and
moving the watercraft away from the berth based on the departure-relevant data.

3. The method as recited in claim 1, wherein the moving of the watercraft includes at least one of manual piloting of the watercraft, autonomous driving of the watercraft, and remotely controlled piloting of the watercraft.

4. The method as recited in claim 1, wherein the transmitting of the request includes transmitting watercraft-specific data to the harbor management server via the communication network, so that the harbor management server may ascertain data to be transmitted to the watercraft based on the watercraft-specific data.

5. The method as recited in claim 1, wherein the received data of the harbor management server include surroundings data, the surrounding data including at least one of current data of the harbor and wind data of the harbor, so that the moving is carried out based on the surroundings data.

6. The method as recited in claim 1, wherein correction data are received from the harbor management server during the moving, so that the movement of the watercraft is corrected based on the correction data.

7. The method as recited in claim 1, wherein watercraft-internal data are monitored and transmitted to the harbor management server via the communication network during the moving.

8. A method for operating a harbor, comprising:
receiving a request for a berth of a harbor for a watercraft via a communication network;
ascertaining berth-relevant data for the watercraft in response to the reception; and
transmitting the berth-relevant data via the communication network, so that the watercraft may be moved to a berth of the harbor based on the berth-relevant data.

9. A method for operating a harbor, comprising:
receiving a request for clearance for a departure of a watercraft located on a berth of the harbor from the berth via a communication network;
ascertaining departure-relevant data for the watercraft in response to the reception; and
transmitting the departure-relevant data via the communication network, so that the watercraft may be moved away from the berth based on the departure-relevant data.

10. The method as recited in claim 8, wherein the watercraft is piloted remotely controlled for the moving of the watercraft.

11. The method as recited in claim 8, wherein a movement of the watercraft is monitored and correction data are ascertained based on the monitoring and transmitted via the communication network, so that the movement of the watercraft may be corrected.

12. The method as recited in claim 8, wherein the receiving of the request includes a reception of watercraft-specific data via the communication network, so that the data to be transmitted to the watercraft are ascertained based on the watercraft-specific data.

13. The method as recited in claim 8, wherein surroundings data are ascertained and transmitted via the communication network so that the movement may be carried out based on the surroundings data, the surroundings data including at least one of current data and wind data.

14. A device for operating a watercraft, configured to:
transmit a request for a berth for the watercraft to a harbor management server of a harbor via a communication network;
receive berth-relevant data from the harbor management server via the communication network; and
move the watercraft to a berth of the harbor based on the berth-relevant data.

15. A harbor management server, which is configured to:
receive a request for a berth of a harbor for a watercraft via a communication network;
ascertain berth-relevant data for the watercraft in response to the reception; and
transmit the berth-relevant data via the communication network, so that the watercraft may be moved to a berth of the harbor based on the berth-relevant data.

16. A watercraft, including a device for operating the watercraft, the device configured to:
transmit a request for a berth for the watercraft to a harbor management server of a harbor via a communication network;
receive berth-relevant data from the harbor management server via the communication network; and
move the watercraft to a berth of the harbor based on the berth-relevant data.

17. A harbor, including a harbor management server, the harbor management server configured to:
receive a request for a berth of a harbor for a watercraft via a communication network;
ascertain berth-relevant data for the watercraft in response to the reception; and
transmit the berth-relevant data via the communication network, so that the watercraft may be moved to a berth of the harbor based on the berth-relevant data.

18. A computer-readable storage medium storing a computer program, the computer code, when executed by a processor, causing the processor to perform:
transmitting a request for a berth for the watercraft to a harbor management server of a harbor via a communication network;
receiving berth-relevant data from the harbor management server via the communication network; and
moving the watercraft to a berth of the harbor based on the berth-relevant data.
